(19) United States
(12) Patent Application Publication
(10) Pub. No.: US 2007/0184688 A1
(43) Pub. Date: Aug. 9, 2007

(54) Interconnection device for a double-sided printed circuit board

(76) Inventors: Cesar Avitia, Chihuahua (MX); Francisco Ceniceros S., Chihuahua (MX); Martin J. Ibarra, Chihuahua (MX)

Correspondence Address: VISTEON, C/O BRINKS HOFER GILSON & LIONE, PO BOX 10395, CHICAGO, IL, 60610, US

(21) Appl. No.: 11/350,133

(22) Filed: Feb. 8, 2006

(51) Int. Cl. H01R 12/00

(52) U.S. Cl. 439/82

(57) ABSTRACT

A circuit board including a conductive device and method for Interconnecting the first and second sides of a printed circuit board. The device includes first and second interconnection portions and an elongated member. The first Interconnection portion contacts a surface of the first side of the printed circuit board and the second Interconnection portion contacts the second side of the printed circuit board. The elongated member has first and second ends. The first end of the elongated member is connected to the first Interconnection portion and the second end of elongated member is connected to the second interconnection portion.

### TECHNICAL FIELD

The present invention relates to double sided printed circuit boards and to systems and methods for interconnecting a first side of the printed circuit board with a second side of the printed circuit board.

### BACKGROUND

Printed circuit boards may be broadly categorized into two types single sided and double sided. Single sided printed circuit board have conductor patterns on one side and double sided printed circuit board have conductor patterns on both sides of the circuit board. In the case of a double sided printed circuit it is necessary to interconnect the conductor patterns on one side with the conductor patterns on the other side. Traditionally plated through holes (PTH) have been used to interconnect the top and bottom sides of a double sided printed circuit board. The plated through holes are holes or bores that extend from one side of the circuit board to the other side and are typically plated with a conductive material such as copper.

Other technologies for interconnecting the printed conductor patterns on one side of a circuit board with the printed conductor patterns on the other side of a circuit board include the use of wire staples. While the use of wire stapes achieves its intended purpose, problems with this technology still exists. For example, the use of wire staples requires axial insertion machines which are becoming obsolete in the industry.

Another method for interconnecting the top and bottom sides of the printed circuit boards is the use of silver filled vias. Silver filled vias are created by filling a hole or bore in the printed circuit board with a conductive polymer such as a silver compound. Once the compound cures, an electrical connection can be made to the via on either side of the circuit board. While the silver filled vias achieve their intended purpose, they are only useful in low current applications. Furthermore, the use of silver filled vias requires an additional process step which could be more costly than other methods. Moreover, the use of plated through holes requires costly board materials such as FR4 or CEM3.

Therefore, a need exists for a new and improved method and system for interconnecting the conductor patterns on the top and bottom surfaces of a double-sided printed circuit board. Such a method and system should utilize, preferably, current surface mount technologies.

### BRIEF SUMMARY OF THE INVENTION

In an aspect of the present invention, a device for interconnecting first and second sides of a printed circuit board is provided. The device includes first and second interconnection portions and an elongated member. The first interconnection portion contacts a surface of the first side of the printed circuit board and the second interconnection portion contacts the second side of the printed circuit board. The elongated member has first and second ends. The first end of the elongated member is connected to the first interconnection portion and the second end of elongated member is connected to the second interconnection portion.

In another aspect of the present invention, one of the first and second interconnection portions includes a flat surface.

In yet another aspect of the present invention, one of the first and second interconnection portions includes a pointed surface.

In yet another aspect of the present invention, the first and second ends of the elongated member are aligned along an elongated member longitudinal axis.

In yet another aspect of the present invention, the first end of the elongated member is offset from the second end of the elongated member.

In still another aspect of the present invention, a length of the elongated member is at least as long as the thickness of the circuit board.

In still another aspect of the present invention, the elongated member has a rectangular cross-section.

In yet another aspect of the present invention, a method for interconnecting a first and second side of a printed circuit board is provided. The method includes contacting a surface of the first side of the printed circuit board with a first interconnection member, contacting the second side of the printed circuit board with a second interconnection portion, and interconnecting a first end of the elongated member to the first interconnected portion and a second end of the elongated member to the second interconnection portion.

Further aspects of the present invention will become apparent by reference to the following description of the preferred embodiments and appended drawings wherein like reference numbers refer to the same components, elements or features.

### BRIEF DESCRIPTION OF THE DRAWINGS

The above, as well as other, aspects of the present invention will become readily apparent to those skilled in the art from the following detailed description of a preferred embodiment when considered in the light of the accompanying drawings.

FIG. 1 is a cross-sectional view through a double-sided printed circuit board illustrating a prior art method for interconnecting circuit patterns on either side of the double-sided printed circuit board.

FIG. 2 is a cross-sectional view through a double-sided circuit board and an interconnection member, in accordance with an embodiment of the present invention;

FIG. 3 is an isometric view of the interconnection member, in accordance with an embodiment of the present invention;

FIG. 4 is a top view of a circuit board incorporating a H head shaped interconnection member shown in FIG. 3, in accordance with an embodiment of the present invention;

FIG. 5 is an isometric view of another embodiment of the interconnection member, in accordance with the present invention;

FIG. 6 is a top view of a circuit board incorporating the interconnection member of FIG. 5, in accordance with the present invention; and

FIG. 7 is a cross-sectional view through the double-sided printed circuit board and the interconnection member shown in FIG. 6, in accordance with the present invention.

### DETAILED DESCRIPTION OF THE INVENTION

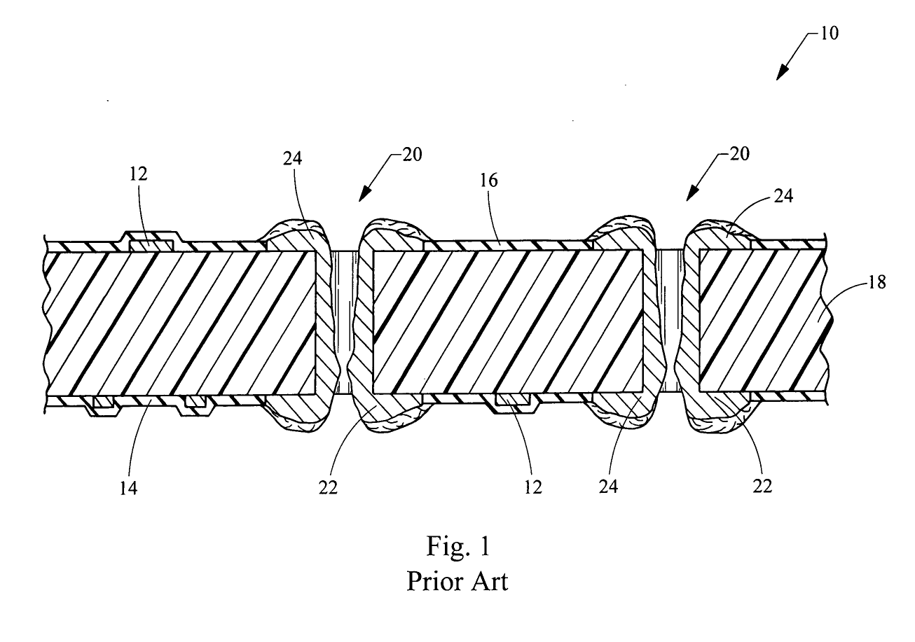

Referring now to FIG. 1, a cross-sectional view through a conventional double-sided printed circuit board 10 is illustrated. Further, FIG. 1 illustrates a prior art method for interconnecting printed circuit patterns 12 on each side 14 and 16 of a substrate 18 of printed circuit board 10. The prior art method shown in FIG. 1 includes the use of coated or plated vias or through holes 20. Plated through holes 20 are through holes having adjacent connector pads 22 that are interconnected with circuit patterns 12 on each side of the substrate 18 of circuit board 10. Deposited copper or silver compound or paste 24 is typically used to form an electrical connection between circuit pads 24 on either side 14 and 16 of double-sided circuit board 10, thus forming a plated through hole or a silver via. One drawback of this prior art method and the use of the silver vias are not capable of carrying high currents.

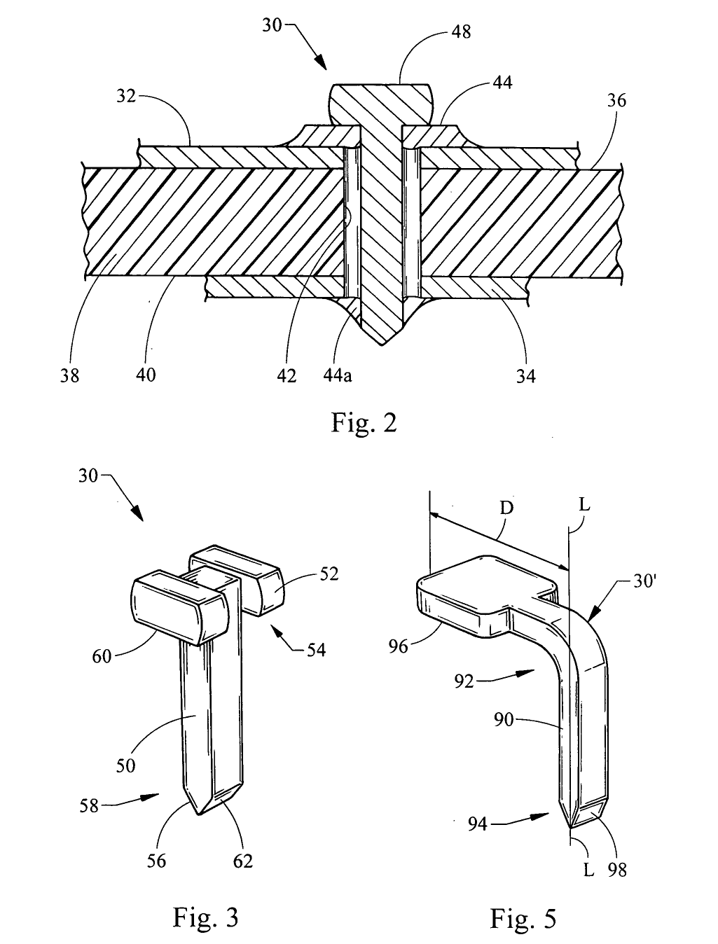

Referring now to FIG. 2, a cross-sectional view through a double-sided circuit board and an interconnection member 30 is illustrated, in accordance with an embodiment of the present invention. Interconnection member 30 electrically connects a first conductor pattern 32 to a second conductor pattern 34. Conductor pattern 32 is affixed to a bottom surface 40 of a double sided circuit board 38 and conductor pattern 34 is affixed to a top surface 40 of circuit board 38. A through hole 42 is provided through conductor patterns 32 and 34 and through the substrate of circuit board 38.

In one embodiment, interconnection member 30 is threaded into bore or hole 42 to interconnect conductive patterns 32 and 34. Interconnection member 30 may be electrically and mechanically connected to conductive pattern 32 using a solder paste 44 and electrically and mechanically connected to conductive pattern 34 using solder 44a. Interconnection member 30 is, for example, nail shaped. Moreover, interconnection member 30 is solderable. Further, interconnection member 30 is configured to be picked from a suitable tray, reel or other container using a pick-and-place machine or other suitable equipment to place member 30 on one side of the dual sided circuit board.

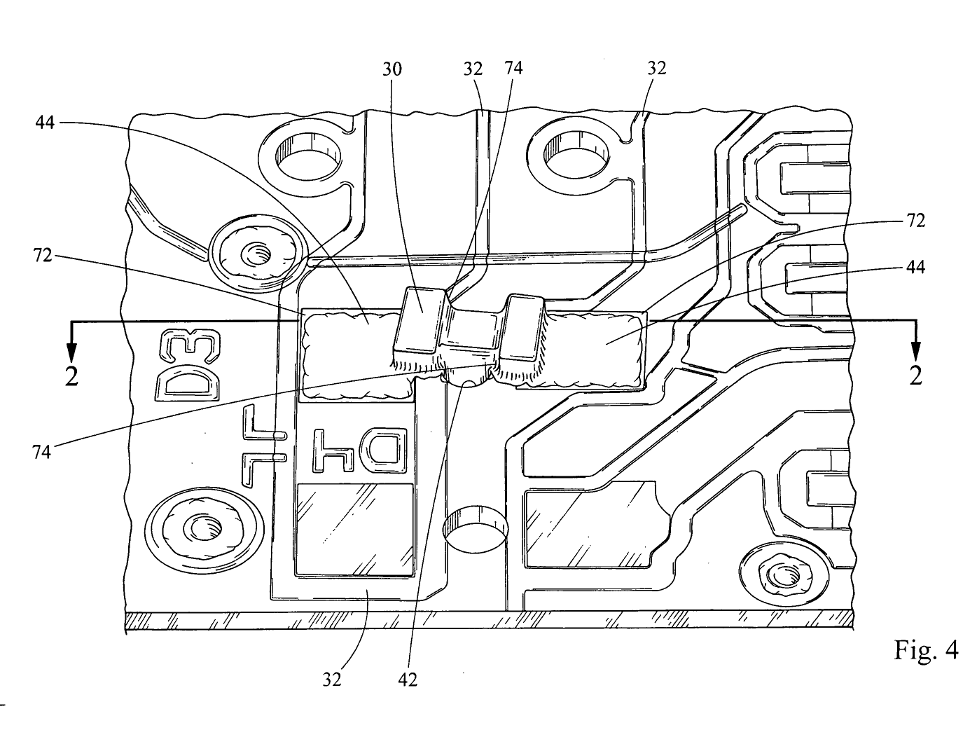

Referring now to FIG. 3, an isometric view of interconnection member 30 is shown, in accordance with an embodiment of the present invention. Interconnection member 30 has an elongated member 50 that includes a first interconnection portion 52 disposed at a first end 54 and a second interconnection portion 56 disposed at a second end 58 of elongated member 50. First interconnection portion 50 has a flat surface 60 that is configured to contact the conductive pattern 32. Second interconnection portion 56 has substantially pointed surface 62 to create a wicking or appropriate flow of solder (illustrated in FIG. 5) to create a connection between end 58 and conductive pattern 34 of dual printed circuit board 38. Further, pointed surface 62 facilitates insertion of interconnection member 30 into through-hole 42. Of course, the present invention contemplates various shapes of interconnection member 30. Namely, first interconnection portion 52 may be circular, rectangular or substantially square in plan view. Second interconnection portion 56 may also take on various shapes including triangular, square, circular and rectangular when viewed in cross-section.

Referring now to FIG. 4, a top view of a circuit board incorporating an “H” shaped head interconnection member 30 is illustrated, in accordance with an embodiment of the present invention. Interconnection member 30 is shown disposed in through hole 42. On either side of through hole 42 are conductive circuit pads 72 that are interconnected with conductor patterns 32 on a first side 40 of dual sided circuit board 38. First interconnection portion 52 of interconnection device 30, in an embodiment of the present invention, includes an H-shaped configuration when viewed from the top, as shown in FIG. 4.

In another aspect of the present invention, a method is provided for creating an electrically and mechanical connection between interconnection device 30 and circuit board 38. The method includes applying a solder paste 44 (shown in FIG. 4) to connector pads 72 of circuit board 38, inserting interconnection device 30 into through hole 42, reflowing the solder paste and wave soldering either one of the surfaces 36 and 40. Reflowing of the solder paste occurs by subjecting the entire circuit board to the heat of an oven or selectively exposing portions of the circuit board having the solder paste to infrared light. The wave soldering is applied at a sufficient rate and quantity to solder interconnection member 30. Advantageously, the method and device of the present invention allows the interconnection of first conductor pattern 32 to second conductor pattern 34 using conventional surface mount equipment. Additionally, the method and device of the present invention may be used with a wide variety of circuit board materials such as, FR4, CEM3 and other suitable, as well as, less costly materials.

Referring now to FIG. 5, an isometric view of another embodiment of an interconnection device 30′ for interconnecting conductor patterns 32, 34 is illustrated, in accordance with the present invention. Interconnection device 30′ has an elongated member 90 that has a first end 92 and a second end 94. Further, elongated member 90 has a longitudinal axis L. Interconnection device 30′ has a first contact portion 96 disposed at end portion 92 of elongated member 90 and a second contact portion 98 disposed at end portion 94 of elongated member 90. First contact portion 92 is offset a predetermined distance d from longitudinal axis 1.

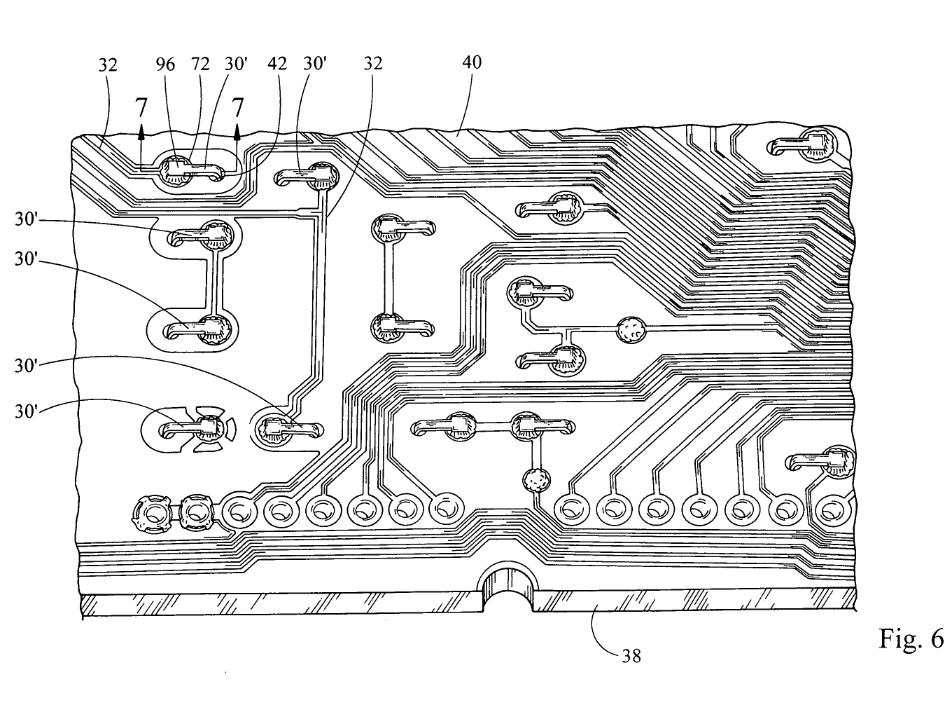

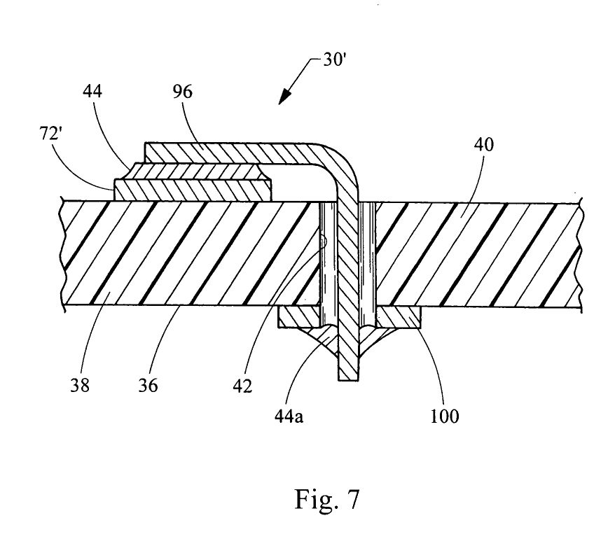

Referring now to FIGS. 6 and 7, plan and cross-sectional views of interconnection member 30′ and circuit board 38 are illustrated, in accordance with another embodiment of the present invention. Interconnection device 30′ is shown inserted into hole 42 of circuit board 38. First contact portion 96 disposed at end portion 92 of elongated member 90 and at a distance d from longitudinal axis L is placed over top of solder pad 72′ and soldered using the above described methods. On the other side 36 of double-sided circuit board 38 a conductive pad 100 is provided adjacent to hole 42. During wave soldering, for example, solder 44 flows over conductive pad 100 and second contact portion 98 disposed at end portion 94 of elongated member 90 forming an electrical and mechanical connection. Thus, the present invention provides an efficient method for interconnecting circuit patterns on either side of a double-sided circuit board.

The foregoing disclosure is the best mode devised by the inventor for practicing this invention. It is apparent, however, that methods incorporating modifications and variations will be obvious to one skilled in the art of double-sided printed circuit boards thereof. Inasmuch as the foregoing disclosure is intended to enable one skilled in the pertinent art to practice the instant invention, it should not be construed to be limited thereby, but should be construed to include such aforementioned obvious variations and be limited only by the spirit and scope of the following claims.

1. (canceled)

2. The circuit board of claim 5 wherein one of the first and second interconnection portions of the device includes a flat surface.

3. The circuit board of claim 5 wherein one of the first and second interconnection portions of the device includes a pointed surface.

4. The circuit board of claim 5 wherein the device has the first and second ends of the elongated member aligned along an elongated member longitudinal axis.

5. A device that provides a conductive path to allow for interconnection of a first and second side of the printed circuit board, the device comprising:
a double sided printed circuit board having portions defining a non-lined through hole therethrough; and
an elongated member having a mid portion disposed along a longitudinal axis, the mid portion being positioned In the non-lined through hole of the circuit board, the elongated member including a first end having a first interconnection portion and a second end having a second interconnection portion, the first Interconnect portion being offset and spaced apart from the mid portion and the second interconnect portion being substantially aligned with the mid portion, the first interconnection portion being connected to a contact portion contacting a first side of the printed circuit board and the second interconnection portion being connected to a second side of the printed circuit board.

6. The circuit board of claim 5 wherein a length of the elongated member is at least as long as the thickness of the circuit board.

7. The circuit board of claim 5 wherein the elongated member has a rectangular cross-section.

8. A device that provides a conductive path to allow for Interconnection of a first and second side of the printed circuit board, the device comprising:
a double sided printed circuit board having portions defining a non-lined through hole therethrough;
an elongated member positioned in the non-lined through hole of the circuit board and connected at a first end to a first Interconnection portion and at a second end to a second interconnection portion;
the first interconnection portion contacting a first side of the printed circuit board;
the second interconnection portion being connected to a second side of the printed circuit board; and
wherein one of the first and second interconnection portions includes an h-shaped surface contacting separate contact pads located on a common surface of the printed circuit board and on opposing sides of the through hole.

9-12. (canceled)

13. The circuit board of claim 8 wherein one of the first and second interconnection portions of the device includes a flat surface.

14. The circuit board of claim 8 wherein one of the first and second interconnection portions of the device includes a pointed surface.

15. The circuit board of claim 8 wherein the device has the first and second ends of the elongated member aligned along an elongated member longitudinal axis.

16. The circuit board of claim 8 wherein a length of the elongated member is at least as long as the thickness of the circuit board.

17. The circuit board of claim 8 wherein the elongated member has a rectangular cross-section.
